(19) United States
(12) Patent Application Publication
(10) Pub. No.: US 2010/0136303 A1
(43) Pub. Date: Jun. 3, 2010

(54) FLOOR PANEL COMPRISING RESIN-IMPREGNATED, PARTICULARLY PAPER LAYERS

(75) Inventors: Reinhard Kreuder, Bad Berleburg (DE); Klaus Fischer, Berghausen (DE)

Correspondence Address: Marlana Titus;Nash & Titus, LLC, 6005 Riggs Road, Laytonsville, MD, 20882, US

(73) Assignee: DEKOR-KUNSTSTOFFE GMBH, Erndtebruck (DE)

(21) Appl. No.: 12/452,968

(22) PCT Filed: Aug. 2, 2007
(86) PCT No.: PCT/EP2007/006841

§ 371 Date: Jan. 29, 2010

(51) Int. Cl. B32B 3/10; B32B 9/04; B32B 29/00; B32B 21/06; B32B 21/08; B32B 27/40; B32B 27/42; B32B 37/00

(52) U.S. Cl. 428/201; 428/411.1; 428/537.5; 428/537.1; 428/423.1; 428/524; 428/195.1; 156/308.2

(57) ABSTRACT

The method relates to a floor panel (100), more particularly a laminate floor, with resin-impregnated, more particularly paper layers (10, 11, 13), which are pressed together with a carrier board (12). In order to design a floor (100) in such a way that a conductive and transparent layer can be positioned at any point in the sequences of layers of the floor panel (100) in order to achieve an antistatic effect the invention proposes providing at least one layer (10, 11, 13) is provided with conductive and transparent pigments (16).

### SUMMARY

1. Technical Field

The invention relates to a floor panel, more particularly a laminate floor panel with resin-impregnated, more particularly paper layers that are pressed with a carrier plate.

The invention also relates to a method of manufacturing the floor panel.

2. State of the Art

Floors known in accordance with the state of the art are decorative layer systems, in the manufacturing of which papers are generally used which are impregnated with heat-hardening resins and pressed together with a carrier plate whereby the optical decorative effect is achieved with a decorative sheet of the impregnated papers.

A floor of the type set out in the introductory section is typically built up in such a way that a so-called overlay paper, impregnated with melamine resin, serves as the uppermost layer, which contains embedded abrasive particles, such as corundum particles, in order to increase the abrasion resistance of the floor.

Under this uppermost layer there is a melamine and/or urethane resin-impregnated printed paper which constitutes the decorative layer of the finished floor. The floor is completed with a melamine and/or urethane resin-impregnated backer paper, the purpose of which is to prevent distortion and warping of the finished floor panels through a symmetrical floor structure.

In the manufacturing process of the flooring of the type set out in the introduction, said resin-impregnated paper layers are combined with a composite wood board serving as a carrier layer by means of short cycle pressing. The composite wood board can, for example, be a particle board or a hard fibre board (HDF). Through the pressing process the uppermost layer, i.e. the overlay layer, becomes completely transparent and on the end product a decorative printed image can be easily recognised, giving the required optical effect.

An alternative product structure consists in the overlay layer being omitted for cost reasons and, instead, the decorative paper being provided with a resin layer on the upper side, which is provided with corundum particles to protect the printed layer.

Due to the insulating properties of the resins used, e.g. melamine and/or urethane resins, the structures set out above have in common the fact that the floors and persons can become strongly statically charged through walking on it, whereby in unfavourable conditions, such as low relative humidity, personal static charges of >10 kV can build up. Floors are generally considered as antistatic (astatic) if in a test procedure carried out in accordance with standard DIN EN 1815 they guarantee a maximum personal charge of 2 kV. If a statically charged person approaches an earthed object an unpleasant discharge can take place. In addition the operation of sensitive electronic devices or components can be impaired if the static charge discharges via them. The use of such flooring in also not possible in areas at risk of explosion due to the spark occurring during discharge.

Therefore, in recent times there have been increasing efforts made to develop antistatic floorings.

The currently available antistatic laminate floor make use of different approaches in order to guarantee personal changes of less than 2 kV in accordance with DIN EN 1815. For this, the charge can be dissipated through sufficiently conductive layers, integrated as additional layers into the above-described sequence of layers. The substances used for dissipating the static charge can either be permanently conductive (graphite, conductive soot, carbon fibres, metal fibres, metal oxides) or their effect can develop through the absorption of moisture which supports the dissipation of charges (salts, ammonium compounds).

The former substances have the drawback that due to their lack of transparency or strong inherent colour they can only be used under the printed layer, i.e. the printed paper. Although the latter compounds can be pressed in resin within certain limits, they have a negative effect on the usage durability and water resistance of the hardened resin surface, and their effect is more climate-dependent as the conductivity is associated with the moisture content of the antistatic layer.

Antistatic floorings are also the subject of discussion in the relevant patent literature.

In German utility model DE 20 2004 002 832 U1 a conductive decorative paper (pre-impregnated) is described which is carried in the paper core with carbon particles via an impregnation process. The disadvantage of this variant is that such papers are not generally available.

The use of ammonium compounds in the resin of the overlay and/or the decorative paper is favoured in German utility model DE 203 18 290 U1 in order to obtain antistatic properties. However, with the quantities of substance used to obtain the antistatic effect a considerable reduction in the water resistance of the surface is usually seen.

Other solutions known from the state of the art use a conductive resin-impregnated intermediate layer paper that is placed and pressed between the printed paper and the composite wood board. However, this increases the costs, particularly of manufacturing the laminate. Another factor against such pressing is that not all manufacturers have the necessary processes available to them.

### DESCRIPTION OF THE INVENTION, OBJECTIVE, SOLUTION, ADVANTAGES

On the basis of the set out disadvantages as well as an evaluation of the indicated state of the art for flooring panels of the type described in the introductory section, the objective of the invention is therefore to design a flooring panel in such a way that a conductive and transparent layer can be positioned at any point in the layer sequence of the flooring in order to achieve an antistatic effect. The antistatic effect should not be associated with a reduction in the water resistance of the surface.

This objective is achieved with the features of claim 1.

Advantageous further embodiments of the invention are set out in the sub-claims.

In accordance with the invention at least one layer is provided with conductive and transparent pigments. Within the context of the invention an impregnated printed decorative paper can be provided with a resin layer which contains a sufficiently high concentration of the conductive and transparent pigment. Alternatively the conductive and transparent pigments can already be incorporated into the resin-impregnated layer through mixing. Through a homogeneous and even distribution of the pigments in the resin coat/resin-impregnated layer contacts, and therefore electrical paths, are formed between the pigments allowing the static charge to be dissipated. Due to its transparency the conductive layers can also lie above the printed paper, i.e. above the decorative printed layer, as because of their transparency the optical effect of the printed paper is not impaired.

The core idea of the invention is therefore to provide a floor, more particularly a laminate floor, with a layer of conductive and transparent pigments in order to obtain in this way an antistatic effect and at the same time preserve the optical effect of the decorative printed layer.

Further advantages of the invention lie in the fact that due to the conductivity of the pigments, e.g. glimmer pigments, the antistatic effect is not moisture-dependent. Therefore there is no antistatic effect operating on the basis of hygroscopic properties and therefore heavily dependent on the relative humidity of the room.

An advantageous embodiment of the invention envisages that the floor has the structure of a laminate floor. Preferably the first layer is therefore an overlay paper that is located over a printed paper functioning as the decorative layer, with the printed paper located above the carrier board and backer paper below the carrier board.

As has already been mentioned, the use of overlay papers is normally cost-intensive. A practicable variant of the invention therefore envisages that a printed paper serving as a decorative layer is located above the carrier board and a backer paper is located under the carrier board, whereby the printed paper is provided with a resin coating on the side facing away from the carrier board. In order to guarantee high abrasion resistance the resin layer is expediently provided with corundum particles.

Preferably the carrier board is a composite wood board, whereby a wood fibre board (HDF) or particle board can be used as the composite wood board.

A practicable variant of the invention envisages that the layers are impregnated with melamine and/or urethane resins. This is of advantage as the papers used within the context of the invention absorb these hardenable fluids well.

A further advantageous embodiment of the invention envisages that the transparent glimmer pigments have a conductive coating. In addition to the advantage of transparency, the conductivity of the glimmer pigments is not, as has already been stated, moisture-dependent. Furthermore, the glimmer pigments do not reduce the water resistance of the resin surface and provide a high degree of long-term stability, as the effective conductive components cannot migrate

In order to guarantee the contact between the individual pigments in the impregnated resin layer/resin coating, a minimum pigment concentration has to be reached or exceeded in the resin layer. Pigment application weights of 0.1-15 g/m², more particularly application weights of 1-5 g/m² have proven to be anti-statically effective with a high degree of transparency.

Expediently the layers are pressure or thermally pressed with the carrier board.

A further advantageous example of embodiment of the floor in accordance with the invention envisages that the printed paper forming the decorative layer floor is provided with a resin coating containing the glimmer pigments. This allows the possibility of positioning a conductive layer above the decorative layer, as in addition to the conductivity, the glimmer pigments also have the necessary transparency to allow the optical evolvement of the decorative layer.

For manufacturing the floor in accordance with the invention a method is suitable in which resin-impregnated paper layers are pressed with a carrier board, whereby before pressing at least one layer of conductive and transparent pigments is added. Here, the pigments are preferably glimmer pigments.

In the method in accordance with the invention the papers designated in the conventional terminology as overlay papers, printed paper (decorative layer) and backer paper are impregnated on both sides with melamine and/or urethane resins. In order to obtain an abrasion-resistant surface of the floor, the overlay paper is impregnated with a resin-corundum mixture, or, as an alternative thereto, the basic paper can already contain abrasion-resistant particles. In a further processing stage the printed paper, which has a weigh per unit area of approximately 50-90 g/m², is additionally provided with a resin coating that contains the conductive glimmer pigment, so that with regard to the glimmer pigment an application weight of 0.1-15 g/m² is obtained. In particular, application weights of 1-5 g/m² have proven to be anti-statically effective and very transparent.

In the manufacturing process of the floor, the resin-impregnated paper layers are combined with a composite wood board acting as a carrier board by means of short cycle pressing at 20 to 40 bars and at a temperature of between 180 and 220° with pressing times of 8 to 20 seconds.

### BRIEF DESCRIPTION OF THE INVENTION

The invention will be described in more detail below in examples of embodiment with the aid of the accompanying drawings. Schematically

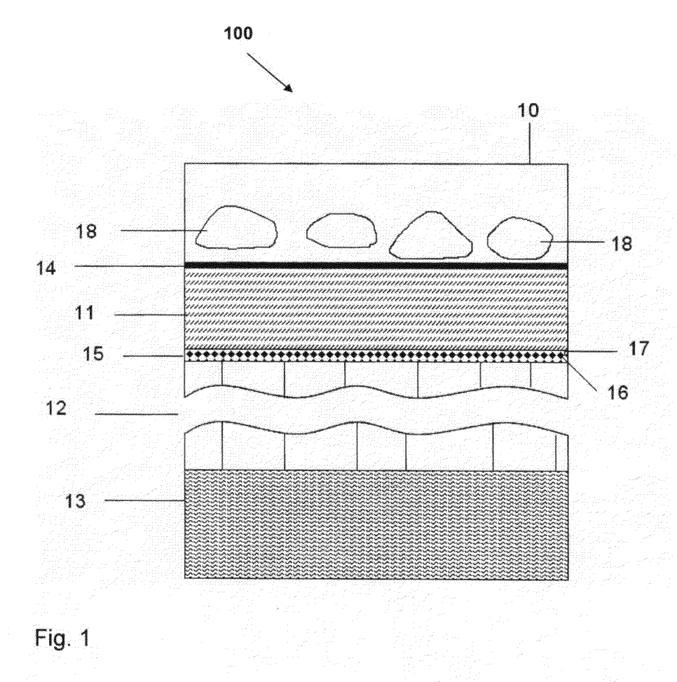

FIG. 1 shows a cross-section of the floor panel in accordance with the invention;

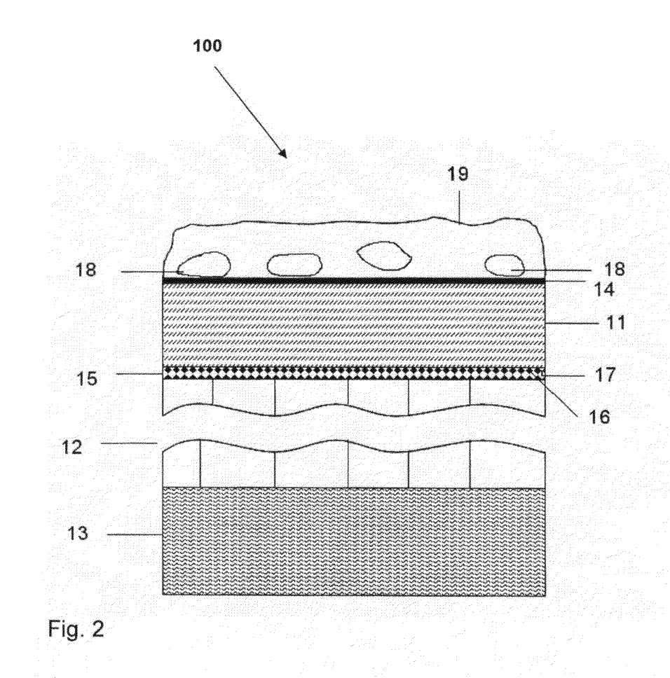

FIG. 2 shows a cross-section of a further embodiment of the floor panel in accordance with the invention in which the overlay paper is replaced with a resin layer; and

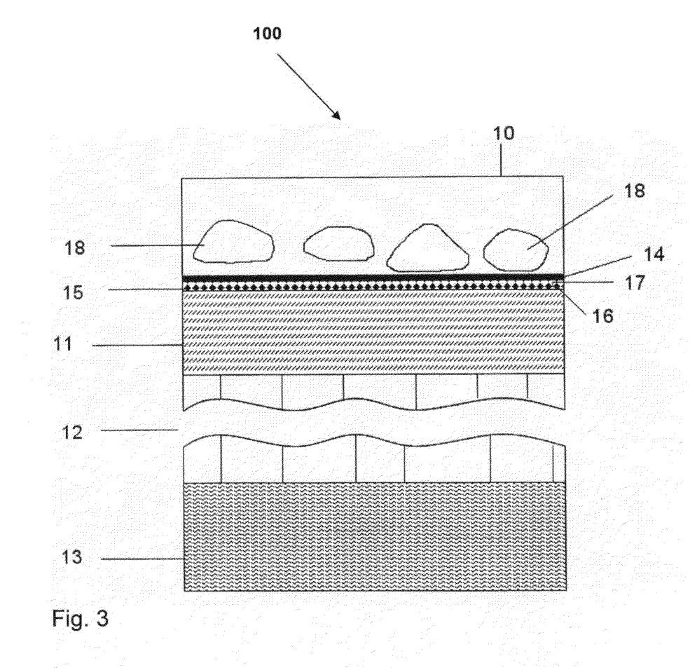

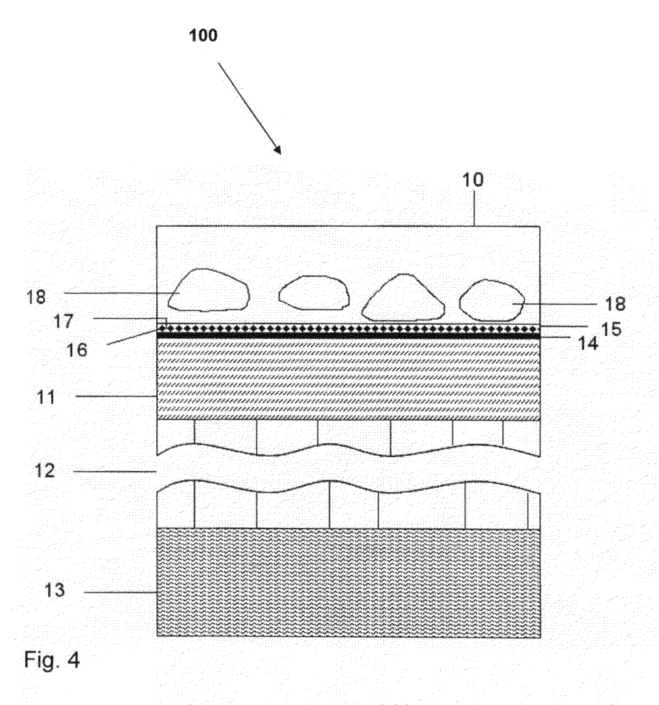

FIG. 3 to FIG. 4 show further embodiments of the floor panel in accordance with the invention.

### BEST WAY OF IMPLEMENTING THE INVENTION

The floor panel shown in FIG. 1, present in the form of a laminate floor panel, is given reference number 100.

In the terminology used here, which is also in conformity with the conventional terminology, the uppermost layer 10 of the structure of the floor panel 100 is overlay paper (overlay film) impregnated with resins in the form of melamine resins. In the embodiment shown here the layer 10 contains embedded abrasive particles 18, such as, for example, corundum particles, in order to increase the abrasion resistance of the floor.

Underneath the layer 10, there is a printed paper, impregnated with melamine and/or urethane resin, which forms the decorative layer 11, also known as the decorative film, of the floor 100.

The floor panel 100 is finished off at the bottom with a layer 13 in the form of a backer paper impregnated with melamine and/or urethane resins. The purpose of the layer 13, also known as backer paper, is mainly to prevent distortion and warping of the finished floor panel.

Arranged between the decorative layer 11 and the layer 13, there is a composite wood board (e.g. a particle board or HDF board) acting as a carrier board 12. As part of the manufacturing process of the floor the layers 10, 11, 13 are combined with the carrier board by means of short cycle pressing at approximately 20 to 40 bars, at a temperature of between 180 and 220° C. with pressing times of 8 to 20 seconds, as a result of which the layer 10, i.e. the impregnated overlay paper becomes completely transparent and the decorative printed image 14 of the decorative layer 11, located directly underneath the layer 10, can be clearly seen.

Layer 11, which in the embodiment shown here has a weight per unit area of approximately 100-150 g/m² is also provided with a resin coating 15 on the side of the floor panel 100 facing away from the user, which contains the conductive glimmer pigment, whereby with regard to the glimmer pigment application weights of 0.1-15 g/m², more particularly 1-5 g/m² are used. The floor panel 100 in the embodiment shown here then exhibits a personal static charge of only 0.46 kV in a walking test in accordance with DIN EN 1815.

The resin coating 15 thereby provides a conductive layer which can also be above the decorative layer 11 due to the transparent properties of the glimmer pigment 16.

FIG. 2 shows an alternative embodiment of the floor panel 100. The floor panel 100 shown in FIG. 2 is formed in such a way that the printed impregnated paper serving as the secondary layer 11 is above the carrier board 12 and an impregnated backer paper is located underneath the carrier board as layer 13, whereby the printed paper has a resin layer 19 on the side turned away from the carrier board, which in order to guarantee the abrasion resistance is provided with abrasive particles, for example, corundum particles. The layers 11, 12, 13 are brought into the press as separate layers.

FIGS. 3 and 4 show further variants that are possible within the framework of the invention. Thus, the resin coating 15 can also be arranged with the pigments 15 underneath and/or above the decorative printed image 14.

### LIST OF REFERENCE NUMBERS

100 Floor panel
10 Layer (overlay film)
11 Layer (decorative film)
12 Carrier board
13 Layer (backer film)
14 Printed image
15 Resin coating
16 Glimmer pigment
17 Pigment contacts
18 Abrasive particles
19 Resin layer

1-17. (canceled)

18. Floor panel comprising resin-impregnated layers which are pressed together with a carrier board wherein at least one layer has transparent and conductive pigments.

19. The floor panel according to claim 18, wherein the floor panel is laminate flooring,

20. The floor panel according to claim 18, wherein the resin-impregnated layers are paper layers.

21. The floor panel according to claim 18 comprising a first layer of impregnated overlay paper, which is arranged on a printed, impregnated paper decorative layer, whereby the printed, impregnated paper decorative layer is positioned above the carrier board and underneath the carrier board is positioned an impregnated backer paper as layer.

22. The floor panel according to claim 18, characterised in that above the carrier board is arranged a printed impregnated paper decorative layer and below the carrier board is arranged an impregnated backer paper layer, whereby on the printed paper is positioned a resin layer on the side facing away from the carrier board.

23. The floor panel according to claim 18, characterised in that the resin-impregnated layer further comprises corundum particles.

24. The floor panel according to claim 18, characterised in that the carrier board is a composite wood board.

25. The floor panel according to claim 24, characterised in that the composite wood board is a wood fibre board or a particle board.

26. The floor panel according to claim 18, wherein the resin-impregnated layers are impregnated with melamine and/or urethane resins.

27. The floor panel according to claim 18, wherein the transparent and conductive pigments are glimmer pigments.

28. The floor panel according to claim 18, wherein the resin-impregnated layers contain pigment in a concentration corresponding to an application weight of the glimmer pigment of 0.1-15 g/m².

29. The floor panel according to claim 18 which further comprises a layer on which is a printed image, whereby the pigments are between a resin-impregnated layer and the printed image and/or between a resin-impregnated layer and the carrier board, and/or between the carrier board and the resin-impregnated layer.

30. The floor panel according to claim 19, wherein the resin-impregnated layers are pressure or thermally pressed with the carrier board.

31. The floor panel according to claim 18, wherein at least one resin-impregnated layer is provided with a resin layer that contains pigments.

32. A method of manufacturing a floor panel, comprising the steps of arranging at least one layer of transparent and conductive pigment on a resin-impregnated layer, followed by pressing resin-impregnated layers with a carrier board.

33. The method according to claim 32, wherein the floor panel is laminate flooring,

34. The method according to claim 32, wherein the resin-impregnated layers are paper layers.

35. The method according to claim 12 wherein a resin coating comprising pigments is applied to at least one resin-impregnated layer.

36. The method according to claim 35 wherein in a first stage the layers are impregnated with a resin, and in a second stage a resin coating containing pigments is provided on one or both sides of at least one resin-impregnated layer.

37. The method according to claim 36 wherein a resin is melamine and/or urethane resin.

38. The method according to claim 32 wherein the pressing is carried out under pressure and/or heat.

39. The method according to claim 32 wherein the pigments are added in the form of glimmer pigments.

40. A floor panel produced by the method of claim 32.
